(19) United States
(12) Patent Application Publication
(10) Pub. No.: US 2004/0135283 A1
(43) Pub. Date: Jul. 15, 2004

(54) Method of making vase/container having a weathered appearance

(76) Inventor: Michael W. Myers, Cave Creek, AZ (US)

Correspondence Address: WEISS & MOY PC, 4204 NORTH BROWN AVENUE, SCOTTSDALE, AZ, 85251, US

(21) Appl. No.: 10/342,413

(22) Filed: Jan. 14, 2003

(51) Int. Cl. B28B 7/36

(52) U.S. Cl. 264/129; 264/333; 264/338; 264/162

(57) ABSTRACT

A method of making a concrete item comprising the steps of: building a mold; preparing a concrete mixture; pouring the concrete mixture into the mold; removing the concrete item from the mold; and chiseling the concrete item with a pneumatic chisel.

### BACKGROUND OF THE INVENTION

1. Field of the Invention

This invention relates generally to pottery and, more specifically, to a method for making pottery and other cement items which will have a weathered appearance.

2. Description of the Prior Art

Pottery has been around for many years. Pottery has many different applications. One such application is the making of vases and the like. People use pottery vases for many different uses. Many people use pottery vases to plant and grow flowers, plants, and the like. The problem is that most pottery vases are fairly small. Thus, larger plants such as trees and the like cannot be planted within a pottery vase. The main reason that pottery vases cannot store larger plants is that most are made of a weak clay material. The clay material is not strong enough to support the weight of the soil and larger plants and trees.

Another problem with current pottery vases is their appearance. Current pottery vases have a very plain and ordinary look. While these vases may be glazed or painted, the look is still not very attractive to some individuals.

Therefore, a need existed to provide an improved method of making pottery vases. The method will allow one to build larger and stronger vases. The method will allow one to build larger and stronger vases which will hold larger plants and trees. The method will further allow one to build larger and stronger vases which will have a weathered appearance.

### SUMMARY OF THE INVENTION

In accordance with one embodiment of the present invention, it is an object of the present invention to provide an improved method of making pottery vases and other cement items.

It is another object of the present invention to provide an improved method of making pottery vases and other cement items that will allow one to build larger and stronger vases/cement items.

It is still another object of the present invention to provide an improved method of making pottery vases and other cement items that will allow one to build larger and stronger vases/cement items which will have a weathered appearance.

### BRIEF DESCRIPTION OF THE EMBODIMENTS

In accordance with one embodiment of the present invention, a method of making a concrete item is disclosed. The method comprises the steps of: building a mold; preparing a concrete mixture; pouring the concrete mixture into the mold; removing the concrete item from the mold; and chiseling the concrete item with a pneumatic chisel to provide a desired finish.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is an elevated perspective view of a vase which was prepared using the present method.

FIG. 1A is a top view of the vase depicted in FIG. 1.

FIG. 2 is an elevated perspective view of another embodiment of a vase that was prepared using the present method.

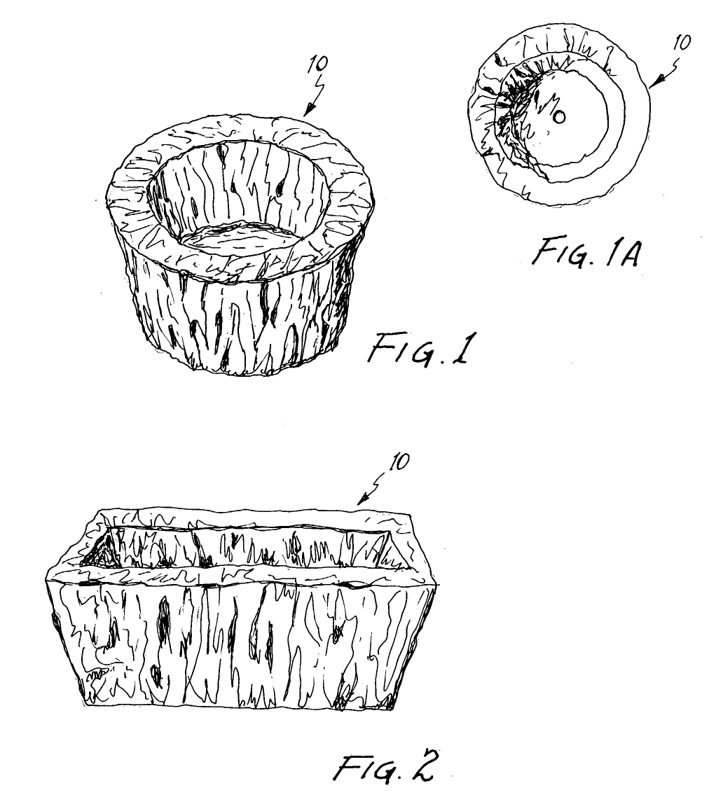

### DETAILED DESCRIPTION OF THE PREFERRED EMBODIMENT

Referring to the Figures, wherein like numerals and symbols represent like elements, a pottery vase/container 10 is shown. The vase/container 10 can be made in any size and is strong enough to hold large potted plants, trees and other items. The vase/container 10 has a unique weathered look which adds to its appeal. It should be noted that while the description is made for a vase/container 10, other items may be made with the below process. For example, concrete doors, arches and the like may be made. The listing of vases/containers, doors, arches, and the like should not be seen as to limit the scope of the present invention.

When building the vase/container 10, a mold is constructed. The mold should be constructed to hold the entire vase/container 10 which is to be built. The mold is generally made from wood. Wood is generally used since wood is inexpensive and easy to use for building and for taking down the mold. However, it should be noted that other items may be used to construct the mold.

Once the mold has been constructed, an interior section of the mold is treated with a repellant. The repellant is used to aid in preventing material from sticking to the side of the mold. In accordance with one embodiment of the present invention, engine fuel is used. An engine fuel like diesel fuel has been shown to prevent concrete from sticking to the mold. However, diesel fuel is just given as an example and should not be seen as to limit the scope of the present invention.

After the mold has been treated with the repellant, the material used to construct the vase/container 10 is poured into the mold. In general, a concrete mixture is used to construct a strong vase/container 10 which is able to hold potted plants, trees and the like. The concrete mixture will generally comprise approximately 49% concrete powder, 50% sand, and 1% lime. These items are placed in a mixer. Water is added to the mixer to blend the contents. The amount of water will depend on a number of different factors. For example, the consistency desired, weather, altitude, amount of water in the sand, etc. However, in general, a water to content ratio of approximately 0.50 is used.

A dye may be added to the cement mixture to add some color to the cement mixture. Any color dye may be used. The use and color of dye is based solely on the consumer's desires. If a dye is added, the dye must be throughly mixed into the cement mixture.

Once the cement mixture has the right consistency, the cement mixture is poured into the mold. The cement mixture is allowed to cure. Once the cement mixture has cured, the mold is removed. In general, one should allow at least 24 hours for the cement mixture to cure before removing the mold.

After the mold has been removed, the vase/container 10 is allowed to cure for an additional time frame. The amount of time is dependent on the consistency of the cement mixture. In general, the vase/container 10 should be allowed to cure for anywhere from 3 to 28 days.

In order to place a unique finish on the vase/container 10, the vase/container 10 is chiseled after the vase/container 10 is allowed to cure. All visible sides of the vase/container 10 should be chiseled to provide a nicer appearance. In general, a pneumatic operated chisel is used. However, this should not be seen as to limit the scope of the present invention. In order to provide different finishes, one may alter the air pressure of the chisel to alter the appearance of the vase/container 10. For example, a lower air pressure will allow one to have a finer finish on the vase/container 10. A higher air pressure on the chisel, on the other hand, will provide a more coarser/weathered appearance. After all the desired areas of the vase/container 10 have been chiseled, an acid stain may be applied to the vase/container 10. The acid stain is used to bring about the desired color on the vase/container 10.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A method of making a concrete item comprising the steps of:
building a mold;
preparing a concrete mixture;
pouring the concrete mixture into the mold;
removing the concrete item from the mold; and
chiseling the concrete item with a pneumatic chisel.

2. The method of claim 1 wherein the step of building a mold further comprises the step of:
building the mold from wood; and
applying a repellant on the interior surface of the mold to prevent the mixture from adhering to the mold.

3. The method of claim 2 wherein the step of applying a repellant further comprises the step of applying diesel fuel to the mold.

4. The method of claim 1 wherein the step of preparing a concrete mixture further comprises the step of:
adding approximately 49% by weight of concrete;
adding approximately 50% by weight of sand;
adding approximately 1% by weight of lime; and
adding and mixing water to the concrete, sand and lime till a desired consistency is obtained.

5. The method of claim 4 further comprising the step of adding a dye to the concrete mixture.

6. The method of claim 4 further comprising the step of curing the concrete mixture within the mold.

7. The method of claim 1 further comprising the step of curing of the concrete item after removing the concrete item from the mold.

8. The method of claim 1 further comprising the step of acid staining the concrete item.

9. A method of making a concrete item comprising the steps of:
building a mold;
applying a repellant on the interior surface of the mold to prevent items from adhering to the mold.
preparing a concrete mixture;
pouring the concrete mixture into the mold;
curing the concrete mixture within the mold;
removing the concrete item from the mold;
curing of the concrete item after removing the concrete item from the mold; and
chiseling the concrete item with a pneumatic chisel.

10. The method of claim 9 wherein the step of building a mold further comprises the step of building the mold from wood.

11. The method of claim 9 wherein the step of applying a repellant further comprises the step of applying diesel fuel to the mold.

12. The method of claim 9 wherein the step of preparing a vase/container mixture further comprises the step of:
adding approximately 49% by weight of concrete;
adding approximately 50% by weight of sand;
adding approximately 1% by weight of lime; and
adding and mixing water to the concrete, sand and lime till a desired consistency is obtained.

13. The method of claim 12 further comprising the step of adding a dye to the concrete mixture.

14. The method of claim 9 further comprising the step of acid staining the concrete item.
